(19) United States
(12) Patent Application Publication
(10) Pub. No.: US 2006/0098684 A1
(43) Pub. Date: May 11, 2006

(54) Data communications system, computer, and data communications method for parallelly operating standard-based and proprietary resources

(76) Inventors: Bruno Bozionek, Borchen (DE); Uwe Langer, Paderborn (DE); Rainer Zimmermann, Paderborn (DE)

Correspondence Address: Siemens Corporation;Intellectual Property Department, 170 Wood Avenue South, Iselin, NJ, 08830, US

(21) Appl. No.: 10/529,720

(22) PCT Filed: Aug. 7, 2003
(86) PCT No.: PCT/DE03/02662

§ 371 Date: Mar. 30, 2005

(30) Foreign Application Priority Data
Sep. 30, 2002 (DE) 10245562.7

(51) Int. Cl. H04J 3/16

(52) U.S. Cl. 370/466; 370/401; 370/352

(57) ABSTRACT

The invention relates to a data communications method, a data communications system, and to a computer for use in a data communications system, whereby the data communications system has several clients. The computer contains a telephone conference and/or video conference data processing device, which supports a first data transmission protocol, and contains another data processing device that supports both the first as well as the second protocol, whereby the second protocol is also supported by clients. The data communications system permits a uniform resource management independent of the type and location of the connected resources and permits a uniform system control interface for monitoring both the H.323 standard as well as TDM/PCM-based proprietary resources.

### CROSS REFERENCE TO RELATED APPLICATIONS

This application is the US National Stage of International Application No. PCT/DE2003/002662, filed Aug. 7, 2003 and claims the benefit thereof. The International Application claims the benefits of German application No. 10245562.7 filed Sep. 30, 2002, both applications are incorporated by reference herein in their entirety.

### FIELD OF THE INVENTION

The invention relates to a data communications system, a computer for use in a data communications system as well as a data communications method.

### BACKGROUND OF THE INVENTION

Data transmission over the Internet is becoming ever more important. The Internet is a worldwide data network or consists—to put it more precisely—of a plurality of different data networks connected to one another via a what are known as routers.

In the Internet one or more central computers in each case communicates with clients arranged remotely from them, e.g. a stationary or portable computer, a telephone etc. (and/or with further central computers).

Communication is undertaken by using what are known as Internet protocols, especially the Transmission Control Protocol (TCP) and the Internet Protocol (IP), abbreviated to TCP/IP.

To this end for example software is loaded on to each client and each central computer which understands the TCP/IP protocol and can evaluate it (socket or TCP/IP stack).

Ever more private data networks (i.e. generally only able to be used by specific authorized persons) are based on the technology and the concept of the Internet. These types of data network of called Intranets.

In an Intranet—as in the Internet—for example a corresponding central computer—using Internet protocols, especially the TCP/IP protocol—communicates with clients arranged remotely from it, e.g. stationary or portable computers, telephones, etc. (and/or with further central computers).

For transmission of the corresponding Intranet data, said data is subdivided into individual packets in each case and then sent asynchronously.

In this way it is possible for example for two clients connected to the Intranet to exchange voice and/or image data; e.g. to telephone each other “(VoIP=Voice over IP), i.e. to exchange voice telephony data and/or image telephony data etc.

Furthermore—more than two, e.g. three, four or five—clients can hold a telephone or video conference over the Intranet.

In this case a computer connected to the Intranet functions as a conference control unit, that is as a “mixer desk” in order to merge or mix the voice and/or video telephony data sent by the clients participating in the conference separately to the computer in each case and then to send the corresponding—mixed—data via the Intranet to the corresponding (remaining) clients participating in the conference.

For exchange of the telephone or video conference data an “open” or standardized protocol based on the TCP/IP protocol, for example the H.323 protocol, can be used.

Alternatively, instead of an individual computer functioning as a conference control unit, a number of conference control computers can also be provided in an Intranet, with each of the computers—based on the above standard protocol, especially the H.323 protocol—at a particular point for a maximum predetermined number of clients to operate as a “mixing desk” or to be able to function as a conference control unit for a predetermined number of telephone or video conferences.

If—because of the overloading—one of the conference control unit computers cannot process a request originating from specific clients for executing a telephone or video conference, another conference control unit computer then takes over control of the corresponding telephone or video conference. (i.e. functions for the relevant clients as conference control unit, especially as “mixing desk”).

Intranets can be connected to the Internet by means of an appropriate central computer, and/or via the same or via a further central computer, e.g. an appropriate telecommunication system, especially a PBX (PBX=Private Branch Exchange) to the telephone network.

Data communication over the telephone network can for example be undertaken on the basis of POTS (Plain Old Telephone Service), or for example on the basis of ISDN (Integrated Services digital Network) data transmission protocols or for example on the basis of xDSL (x digital Subscriber Line) data transmission protocols, e.g. by means of ADSL data transmission (ADSL=Asynchronous Digital Subscriber Line).

With the aid of the telecommunications system or the PBX computer it is made possible for specific clients connected to the Intranet, e.g. telephones, to communicate with external devices connected to a telephone network, e.g. telephones.

For communication between the PBX computer and the clients a proprietary protocol based for example on the TCP/IP protocol can be used.

### SUMMARY OF THE INVENTION

If a telephone conference is to be held between a number (especially more than two, e.g. three, four or five) external and/or internal TDM or PCM clients or devices, the relevant PBX computer can function as a conference control unit, especially as a “mixing desk” in order to merge or mix the (speech) data sent from the various clients or devices participating in the conference separately to the PBX computer and then to send the corresponding—mixed—data to the appropriate (remaining) clients or devices taking part in the conference, especially telephones.

The object of the invention is to make available an innovative data communications system, an innovative computer as well as an innovative data communications method.

This is achieved by the claims.

Advantageous developments of the invention are specified in the dependent claims.

In accordance with the basic idea of the invention a data communications system with a number of clients is made available, with a telephone and/or video-conference data processing unit which supports a specific first data transmission protocol being provided, and a data processing unit supporting both of the first and the second data transmission protocol converting the received data and forwarding it to the telephone and/or video conference data processing unit such that clients which support both first and also the second data transmission protocol can be used.

Advantageously the second data transmission protocol can be an open, standardized protocol, e.g. an H.323 or H.225/H.245-based protocol, and the first data transmission protocol a proprietary or generic protocol e.g. a PCM or TDM-based protocol.

This makes it possible—unlike in the prior art—to operate H.323 standard-based and proprietary, e.g. PCM or TDM-based resources, in parallel.

The invention is explained in more detail below with reference to a number of exemplary embodiments and the enclosed drawing.

### BRIEF DESCRIPTION OF THE DRAWINGS

FIG. 1: shows a schematic diagram of a data communications system in accordance with an exemplary embodiment of the invention; and

FIG. 2: shows a schematic diagram of the structure and the operation of a communication control computer used in the system shown in FIG. 1.

### DETAILED DESCRIPTION OF THE INVENTION

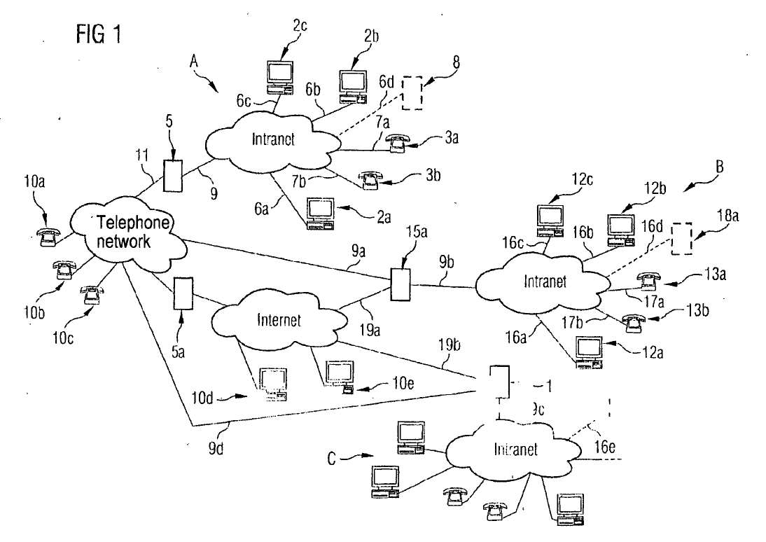

In the data communications system 1 shown in FIG. 1 a plurality (e.g. 5-300, especially 10-150) clients 2a, 2b, 2c, 3a, 3b, e.g. a number of telephones 3a, 3b, and number of computers 2a, 2b, 2c, are connected to a first Intranet data network A.

The first Intranet data network A features a telecommunications system or a central computer 5 functioning as a telecommunications system, especially a PBX computer (PBX=Private Branch Exchange) which functions as a communication control device for clients 2a, 2b, 2c, 3a, 3b, especially as a telephone switching system in order to connect the first Intranet data network A (or the clients 2a, 2b, 2c, 3a, 3b connected to it) with a telephone network (e.g. with the public telephone network).

The connection of the central computer 5 or the clients 2a, 2b, 2c, 3a, 3b to the first Intranet data network A can for example be undertaken by lines 6a, 6b, 6c, 7a, 7b, 9 connected to a corresponding bus system.

The Clients 2a, 2b, 2c, 3a, 3b and the central computer 5 communicate—as explained in greater detail below—using Internet protocols, e.g. the Transmission Control Protocol (TCP) or the Internet Protocol (IP), abbreviated to TCP/IP.

To this end for example software (known as a stack) is loaded onto the relevant client 2a, 2b, 2c, 3a, 3b or onto the central computer 5, which can understand and interpret the corresponding Internet protocol.

For transmission of data between the clients 2a, 2b, 2c, 3a, 3b and the central computer 5 over the first Intranet data network A this data—as is usual with Internet protocols—is divided up into individual packets.

If one of the clients 2a, 2b, 2c, 3a, 3b communicates—via the telephone network—with a corresponding external device not connected directly to the first Intranet data network A (e.g. a telephone 10a, 10b, 10c), the corresponding data sent (by the relevant client 2a, 2b, 2c, 3a, 3b in the above way, i.e. as Internet protocol-based data, is converted by the central computer 5 into corresponding POTS (Plain Old Telephone Service), ISDN (Integrated Services digital Network), or xDSL—(x digital Subscriber Line) data and is output over a line 11 to the telephone network (or conversely the ISDN or POTS data received from the relevant telephones 10a, 10b, 10c over the telephone network is forwarded by the central computer 5 in the above-mentioned way via the Intranet data network A to the relevant Client 2a, 2b, 2c, 3a, 3b).

As shown in more detail in FIG. 1, the Intranet data network can be connected via the telecommunication system or the central computer 5—not only to the telephone network—but also (if necessary) to the Internet (and this can be done—indirectly—over the telephone network and a computer 5a of a ISP (Internet Service Provider)).

Should one of the clients 2a, 2b, 2c, 3a, 3b communicate with a device connected to the Internet, e.g. a computer 10d, 10e, a telephone connection is established by the central computer 5 (e.g. a POTS, ISDN, or xDSL, especially ADSL connection) to the ISP computer 5a, which then assigns to the central computer 5 or to the relevant client 2a, 2b, 2c, 3a, 3b a temporary IP address (Internet Protocol address) and causes a corresponding Internet connection to be set up (so that then—over the Internet, and the telephone network (and through the intermediate connection of the ISP computer 5a, and of the central computer 5) data can be exchanged between the relevant client 2a, 2b, 2c, 3a, 3b, and the relevant computer 10d, 10e).

In accordance with FIG. 1 the data communications system 1—apart from the first Intranet data network A—features a plurality of further Intranet data networks connected or connectable to the first Intranet data network A, e.g. a second Intranet data network B, and a third Intranet data network C, etc.

The second and third Intranet data network B, C each feature—just like the first Intranet data network A—a plurality (e.g. 5-300, especially 10-150) clients 12a, 12b, 12c, 13a, 13b, e.g. a number of telephones 13a, 13b, and a number of computers 12a, 12b, 12c.

The second and third Intranet data network B, C are also—as well as being connected to the above telephone network—connected to the Internet, and are connected, by contrast with the first Intranet data network A, directly and permanently e.g. by means of corresponding (fixed) dedicated connections 19a, 19b.

The second and third Intranet data network B, C each feature—in the same way as the first Intranet data network A, a telecommunications system in each case or a central computer operating as a telecommunications system 15a, 15b, especially a PBX computer (PBX=Private Branch Exchange) which operates as a communication network control device for the clients 12a, 12b, 12c, 13a, 13b, especially as a switching device in order to connect the Intranet data network (or the clients 12a, 12b, 12c, 13a, 13b connected to it) to the telephone network or the Internet. The relevant central computer 15a, 15b is permanently connected to the Internet via the corresponding dedicated connection 19a, 19b (i.e. permanently “online).

The connection of the relevant central computer 15a, 15b or the clients 12a, 12b, 12c, 13a, 13b to the second or third Intranet data network B, C can for example be made in the same way as for the first Intranet data network A by means of lines 16a, 16b, 16c, 17a, 17b, 9b, 9c connected to a corresponding bus system.

The clients 12a, 12b, 12c, 13a, 13b and the relevant central computer 15a, 15b communicate—as will be explained in more detail below—by using Internet protocols, e.g. the Transmission Control Protocol (TCP) or the Internet Protocol (IP), abbreviated to TCP/IP.

To this end for example software (known as a stack) is loaded onto the relevant client 12a, 12b, 12c, 13a, 13b or onto the relevant central computer 15a or 15b which can understand and interpret the corresponding Internet protocol.

If one of the clients 12a, 12b, 12c, 13a, 13b communicates with a corresponding external device not connected directly to the Intranet data network but connected to the telephone network (e.g. the above-mentioned telephone 10b), the corresponding data sent (by the relevant client 12a, 12b, 12c, 13a, 13b in the above way, i.e. Internet protocol-based) will be converted by the relevant central computer 15a, 15b into corresponding POTS, ISDN or xDSL data output to the telephone network via a line 9a, 9d (or conversely the POTS, ISDN or xDSL data received by the telephone 10b over the a telephone network will be forwarded by the relevant central computer 15a, 15b in the above way via the Intranet data network B, C to the relevant client 12a, 12b, 12c, 13a, 13b).

The relevant central computer 15a, 15b or the clients 12a, 12b, 12c, 13a, 13b connected to it have a permanent address—consisting of a multidigit number—(Internet Protocol address), so that, after the corresponding Internet connection is established, data can be exchanged between a corresponding device connected to the Internet, e.g. the above-mentioned computer 10d, and the relevant central computer 15a, 15b or—by interconnecting the relevant central computer 15a, 15b—between the relevant device connected to the Internet, e.g. the computer 10d, and the relevant client 12a, 12b, 12c, 13a, 13b.

As is also shown in FIG. 1, the data communications system 1—alternatively—can feature one at more central computers 8, 18a, 18b each connected by corresponding lines 6d, 16d, 16e to the relevant Intranet data network A, B, C (or to the corresponding bus system) (shown by dashed lines in FIG. 1), which—in the conventional way known per se, can be used as control units for executing the corresponding telephone and/or video conferences (but which can also—as explained in more detail below—can be dispensed with with the present data communications system 1, or for which the function can be taken over by the above telecommunications systems or central PBX computers 5, 15a, 15b).

The corresponding central computer 8, 18a, 18b operates in one function as a “mixing desk” in order to merge the voice and/or video telephony data sent by the various clients participating in the conference (e.g. the clients 2a, 2b, 12a) over the corresponding Intranet data networks A, B, C separately in each case to the corresponding central computer 8, 18a, 18b, and then to send the corresponding mixed data over the relevant Intranet data networks A, B, C to the corresponding (remaining) clients 2a, 2b, 12a participating in a conference.

For data transmission or for control of the data transmission in this case an “open” or standardized protocol based on the TCP/IP protocol is used, for example the H.225/H.245 or H.323 protocol.

To this end software must be loaded on a memory device (not shown here-) of the corresponding clients 2a, 2b, 12a or central computer 8, 18a, 18b which supports the corresponding H.225/H.245 or H.323 protocol (in particular can understand it and evaluate it).

Each central computer 8, 18a, 18b can—at a specific point in time—functions for a maximum predetermined number of clients 2a, 2b, 12a as a “mixing desk” or for a maximum predetermined number of telephone or video conferences to be conducted simultaneously as a conference control unit.

If—as a result of overloading—a request made to the central computer 8, 18a, 18b by specific clients 2a, 2b, 12a for processing a telephone or video conference cannot be processed, another central computer 8, 18a, 18b then takes over the control of the corresponding telephone or video conference (i.e. operates for the relevant clients 2, 2b, 12a as a conference control unit, especially as a “mixing desk”).

As will be explained in more detail below, for the data communications system 1 shown in FIG. 1 for communication between the corresponding PBX computers 5, 15a, 15b (PBX=Private Branch Exchange) and the relevant clients 2a, 2b, 2c, 3a, 3b, 12a, 12b, 12c, 13a, 13b—parallel—e.g. both a company-specific proprietary protocol based on the TCP/IP protocol can be used (e.g. a generic protocol of Siemens AG), for example a corresponding conventional TDM or PCM protocol (TDM=Time Division Multiple, PCM=Pulse Code Modulation), and an “open” or standardized protocol—also based on the TCP/IP protocol—e.g. the above-mentioned H.225/H.245 or H.323 protocol (which is why the PBX computer 5, 15a, 15b—as is clear from the following presentation—can take over one of the corresponding functions of the central computer 8, 18a, 18b as control unit for executing the corresponding, H.225/H.245—or H.323 protocol-based and/or TDM/PCM protocol-based telephone and/or video conferences (i.e. the central computer 8, 18a, 18b can—alternatively—be dispensed with)).

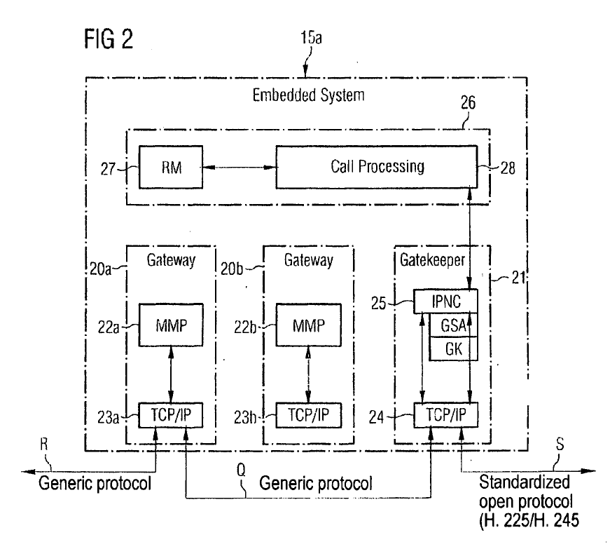

As shown in FIG. 2, the PBX computers (here: the PBX computer 15a, and correspondingly also the—constructed and set up in the same way as PBX computer 15a—PBX computers 5, 15b) feature for this purpose at least one module 20a which takes over the function of the gateway (or a number, e.g. between two and seven, gateway modules 20b, which are constructed and set up in a similar way to gateway module 20a), as well as a (especially precisely one) module 21 which takes over a gatekeeper function.

The PBX computer 15a is embodied in the present exemplary embodiment as a proprietary computer system (i.e. as an “embedded system”), alternatively an embodiment as a (non-proprietary PC system is for example also conceivable.

The gateway module 20a, 20b is set up so that it communicates—both with the gatekeeper-module 21 (cf. arrow Q), and also with the corresponding clients 2a, 2b, 2c, 3a, 3b, 12a, 12b, 12c, 13a, 13b (cf. arrow R)—(exclusively) via the above generic or proprietary protocol based on the TCP/IP protocol, especially the TDM or PCM protocol.

To this end software must be loaded on a memory device (not shown here) of the gateway module 20a, 20b, especially a TDM/PCM switching matrix access device 23a, 23b, which supports the corresponding TDM/PCM protocol (i.e. can understand and evaluate it).

As is also shown in FIG. 2, the gateway module 20a, 20b features a data processing device 22a, 22b which has a DSP, especially an MMP (DSP=Digital Signal Processor; MMP=Multi Media processor), which—via the TDM/PCM switching matrix access device 23a, 23b—is connected to the TDM/PCM switching matrix (so that the gateway module 20a, 20b, especially the MMP data processing device 22a, 22b, can communicate with the gatekeeper module 21—arrow Q—or with one or more clients 2a, 2b, 2c, 3a, 3b, 12a, 12b, 12c, 13a, 13b—arrow R).

If a telephone and/or video conference is to be held between a number (especially more than two, e.g. three, four or five) internal clients 12a, 12b, 12c, 13a, 13b (i.e. clients 12a, 12b, 12c, 13a, 13b contained in the same Intranet data network B as the central control PBX computer 15a controlling the communication in each case) and/or external clients 2a, 2b, 2c, 3a, 3b (i.e. clients 2a, 2b, 2c, 3a, 3b contained in an Intranet data network A, C other than the central control PBX computer 15a controlling the communication in each case), as explained in more detail below—the gateway module 20a provided in the relevant PBX computer 15a (if nec. correspondingly selected by the gatekeeper module 21) (especially the MMP data processing device 22a) operates as a “mixing desk”, in order to merge or to mix the voice or image data sent separately in each case to the PBX computer 15a by the clients 2a, 2b, 2c, 3a, 3b, 12a, 12b, 12c, 13a, 13b participating in the conference.

In this case the data can be sent from the corresponding clients 2a, 2b, 2c, 3a, 3b, 12a, 12b, 12c, 13a, 13b—depending on whether they support the above “open” or standardized, H.225/H.245 or H.323 protocol, or the above proprietary or generic TDM/PCM protocol—in any way in accordance either H.225/H.245—or H.323 protocol-based or TDM/PCM protocol based (in which case—for transmission based on an H.225/H.245 or H.323 protocol—the data (unlike the data transmitted with the TDM/PCM protocol) is not directly evaluated by the gateway module 20a (as is correspondingly shown by the arrow R), but on the gatekeeper module 21 is first converted into the corresponding TDM/PCM protocol-based data, and then forwarded to the gateway module 20a (as is correspondingly shown by the arrow S and the arrow Q)).

The—correspondingly mixed—data is always output by the gateway module 20a in the form of TDM/PCM protocol-based data (in which case—before the sending of the data to only clients 2a, 2b, 2c, 3a, 3b, 12a, 12b, 12c, 13a, 13b that support the above standardized, H.225/H.245 or H.323 protocol, but not the above proprietary or generic TDM/PCM protocol—the data (unlike for clients 2a, 2b, 2c, 3a, 3b, 12a, 12b, 12c, 13a, 13b that support the TDM/PCM protocol) is not forwarded directly to the corresponding clients (correspondingly shown by the arrow R), but is first converted by the gatekeeper module 21 into the corresponding H.225/H.245 or H.323 protocol-based data and only then forwarded to the corresponding clients 2a, 2b, 2c, 3a, 3b, 12a, 12b, 12c, 13a, 13b (correspondingly shown by the arrow S and the arrow Q))—the corresponding protocols or the protocol selection will thus be “encapsulated” by the gatekeeper module 21.

As well as the above-mentioned “mixing desk” function, the gateway module 20a fulfills for all clients provided, especially involved in the relevant communications network process, e.g. the corresponding telephone and/or video conference, clients 2a, 2b, 2c, 3a, 3b, 12a, 12b, 12c, 13a, 13b what is known as a “Music On Hold” function (MoH function i.e. plays at appropriate points—e.g. during the switching process—for the corresponding clients 2a, 2b, 2c, 3a, 3b, 12a, 12b, 12c, 13a, 13b, the appropriate voice or tone signals stored on a memory device not shown in the diagram (or the corresponding image signals) (e.g. an interim melody).

Furthermore—as already explained above—the corresponding gateway module 20a (especially the TDM/PCM switching matrix access module 23a provided there) looks after the transmission of the data to, or the receipt of the data from, the TDM/PCM switching matrix network (e.g.—via the line 9b—over the internal Intranet data network B, or—for example via the line 9a—over the external telephone network). (By contrast an interface device 24 provided at the gatekeeper module 20b takes care—as required—of either TDM/PCM or H.225/H.245 protocol-based data transmission (e.g.—via the line 9b—via the internal Intranet data network B, or—for example via the line 19a—externally over the Internet)).

The control of the gateway module 20a (as well as of the further gateway modules 20b provided if necessary, and—where necessary further resources in the data communications system 1 for executing the corresponding telephone and/or video conferences, or suitable as a mixing desk e.g. TDM/PCM-based “resources”, especially of gateway modules existing (e.g. in the further Intranet data networks A, C)—if these are just available—) is undertaken by an IP network control device 25 or an IP Network Controller (IPNC) provided in the gatekeeper module 21 (and this is done—as shown in FIG. 2 by the arrow Q—by sending corresponding TDM/PCM protocol-based control data).

Correspondingly the control of corresponding H.225/H.245 or H.323 protocol based “resources”—present in the relevant Intranet data network B, e.g. of resources just available—provided by the above-mentioned central computer 18a and if necessary of further—just available—H.225/H.245—or H.323 protocol-based resources in the data communications system 1 for executing the corresponding telephone and/or video conferences or suitable as a mixing desk, especially the above resources in the further Intranet data networks A, C (or for example in the Internet) made available by the central computer 8, 18b, are also controlled by the network control device provided in the gatekeeper module 21 (and this is done—as shown in FIG. 2 by the arrow S—by sending the corresponding H.225/H.245 or H.323 protocol-based control data).

The PBX computer 15a, especially the gatekeeper module 21 can thus access under the control of the IP network Controller 25—(as required) both resources present in the relevant Intranet data networks B, i.e. “locally” as well as remote resources available in other Intranet data networks A, B or which can be called up via the Internet or the telephone network (and can optionally do this for example by using the H.225/H.245 protocol, or for example the TDM/PCM protocol—which enables both H.323 protocol and also TDM/PCM protocol-based resources to be used).

Each “resource” (i.e. each gateway-module 20a, 20b, each computer 8, 18a, 18b, etc.) can—at a particular point in time—be used for a maximum predetermined number of clients 2a, 2b, 2c, 3a, 3b, 12a, 12b, 12c, 13a, 13b as a “mixing desk” (or—at a particular point in time—undertake the appropriate data processing for a maximum predetermined number of telephone or video conferences).

The resources are allocated—at the corresponding request of the clients 2a, 2b, 2c, 3a, 3b, 12a, 12b, 12c, 13a, 13b—(depending on the load at the time or the availability of resources) by a resource control device 26 featuring a resource management (RM) device 27 and a Call Processing (CP) device 28 )—communicating with the above network control device 25.

If—as a result of an overload—a corresponding resource cannot process a request originating from specific clients 2a, 2b, 2c, 3a, 3b, 12a, 12b, 12c, 13a, 13b for executing a telephone or video conference, the gatekeeper module 21 (or more precisely the resource control device 26 via the IP network control device 25), by sending the corresponding TDM/PCM or H.225/H.245 or H.323 protocol-based control data, causes another of the above resources to take over the corresponding telephone or video conference (i.e. functions as a “mixing desk” for the relevant clients 2a, 2b, 2c, 3a, 3b, 12a, 12b, 12c, 13a, 13b).

Uniform resource management is achieved in this way, independent of the type and of the location of the connected resources, or a uniform system control interface for control or both H.323 standard and also TDM/PCM-based, proprietary resources.

In this case, by the modularization/splitting of the gatekeeper and gateway functions onto different modules, H.323 stack license costs can be saved.

1.-18. (canceled)

19. A data communications system, comprising:
a plurality of clients;
a plurality of telephone and/or video conference data processing devices supporting a first data transmission protocol;
a data processing device supporting the first and a second data transmission protocol, wherein the data processing device converts and forwards data to a telephone and/or video conference data processing device such that this data can be used by clients supporting the first and the second data transmission protocol; and
a resource control device, which in cases in which a request cannot be processed by a telephone and/or video conference data processing device, causes another telephone and/or video conference data processing device to take over the request.

20. The data communications system in accordance with claim 19, wherein the telephone and/or video conference data processing device and the data processing device are arranged in a computer.

21. The data communications system in accordance with claim 20, wherein the computer is a server.

22. The data communications system in accordance with claim 20, wherein the computer is a PBX computer.

23. The data communications system in accordance with claim 19, wherein the second data transmission protocol is an open, standardized protocol.

24. The data communications system in accordance with claim 23, wherein the second data transmission protocol is an H.323 or H.225/H.245-based protocol or an SIP-based protocol.

25. The data communications system in accordance with claim 19, wherein the first data transmission protocol is a proprietary or generic protocol.

26. The data communications system in accordance with claim 19, wherein the first data transmission protocol is a PCM- or TDM-based protocol.

27. The data communications system in accordance with claim 19, wherein the first and/or the second data transmission protocol is a TCP/IP-based data transmission protocol.

28. The data communications system in accordance with claim 19, wherein clients supporting the first data transmission protocol and clients supporting the second data transmission protocol can jointly hold a telephone and/or video conference with each other simultaneously by using the telephone and/or video conference data processing device.

29. The data communications system in accordance with claim 19, wherein one or more of the clients are connected to an Intranet data network.

30. The data communications system in accordance with claim 29, wherein one or more of the clients are arranged outside the Intranet data network.

31. The data communications system in accordance with claim 30, wherein one or more of the clients are connected to a further Intranet data network.

32. The data communications system in accordance with claim 19, wherein the telephone and/or video conference data processing unit is connected to the Intranet data network.

33. The data communications system in accordance with claim 19, wherein a further telephone and/or video conference data processing device supporting the first data transmission protocol is provided which can be used instead of the telephone and/or video conference data processing device.

34. The data communications system in accordance with claim 33, wherein the further telephone and/or video conference data processing device is connected to the Intranet data network, or wherein the further telephone and/or video conference data processing device is arranged outside the Intranet data network.

35. The data communications system in accordance with claim 19, wherein an additional telephone and/or video conference data processing device supporting the second data transmission protocol is provided, which can be used instead of the telephone and/or video conference data processing device.

36. The data communications system in accordance with claim 35, wherein the additional telephone and/or video conference data processing device is connected to the Intranet data network, or wherein the additional telephone and/or video conference data processing device is arranged outside the Intranet data network is connected to a further Intranet data network.

37. A computer adapted be used in a in a data communications system, the computer comprising:
a plurality of telephone and/or video conference data processing devices supporting a first data transmission protocol;
a data processing device supporting both the first, and also a second data transmission protocol, the data processing device converts received data and forwards this data to one of the telephone and/or video conference data processing devices, so that this data can be used by clients supporting both the first and also the second data transmission protocol; and
a resource control device which in cases in which a request cannot be processed by one of the telephone and/or video conference data processing devices, causes another of the telephone and/or video conference data processing devices to take over the request.

38. A data communications method for use in a data communications system comprising a number of clients, a plurality of telephone and/or video conference data processing devices supporting a first data transmission protocol, a data processing device supporting both the first, and also a second data transmission protocol, and a resource-control device, the method comprising:
converting received data by the data processing device; and
forwarding the data to a telephone and/or video conference data processing device such that this data can be used by clients supporting both the first, and also the second data transmission protocol, wherein, in cases in which a request cannot be processed by the telephone and/or video conference data processing device another telephone and/or video conference data processing device is triggered to take over the request.
